(19) United States
(12) Patent Application Publication
(10) Pub. No.: US 2026/0365214 A1
(43) Pub. Date: Nov. 19, 2026

(54) MOBILE TEMPERATURE CART

(71) Applicant: Mastercard International Incorporated, Purchase, NY (US)

(72) Inventor: Daniel Canavan, Lake Saint Louis, MO (US)

(73) Assignee: Mastercard International Incorporated, Purchase, NY (US)

(21) Appl. No.: 19/207,873

(22) Filed: May 14, 2025

(51) Int. Cl. B62B 5/00; G01K 1/14; G01K 13/00

(52) U.S. Cl. CPC B62B 5/00; G01K 1/14; G01K 13/00

(57) ABSTRACT

A data center temperature cart and method of obtaining consistent server cabinet temperature readings throughout a data center. The cart includes a support frame traveling on wheels, a sensor support, multiple temperature sensors, and a sensor reading device. The support frame has an outer perimeter and an inner perimeter defining an air flow region of one or more openings that allow air flow therethrough from perforated floor tiles. The sensor support extends vertically from the support frame. The temperature sensors are attached to the sensor support and face away from the support frame. A first temperature sensor is attached to a lower portion of the sensor support and a second temperature sensor is attached to an upper portion of the sensor support. The sensor reading device is communicably coupled to the temperature sensors and stores / displays temperature readings from the temperature sensors.

### BACKGROUND

Data centers or other such server rooms can be designed to house and support a large number of servers and other IT infrastructure for one or more organizations. Data centers can have numerous server cabinets or server racks that hold and organize numerous servers, routers, switches, and the like. Such data centers generally require advanced cooling and power infrastructure.

In order to ensure that each server cabinet or server rack in a server room or data center is maintained at an appropriate temperature, regular checks can be conducted by technicians using infrared heat equipment or the like. However, such techniques are prone to human error and can be time consuming. Another technique is to place multiple temperature sensors throughout the server room or data center, but this can be an initial costly investment for so many sensors and can lead to large costs down the road as numerous sensors would need to be maintained (e.g., battery replacements or sensor replacements).

Thus, there is a need for an improved system and method for regularly measuring server cabinet temperatures without suffering from the deficiencies of the prior art.

### SUMMARY

Embodiments of the current technology described herein address one or more of the above-mentioned problems and provide a distinct advance in the art of data center or server room temperature monitoring. In one embodiment, a data center temperature cart includes a support frame having an outer perimeter and an inner perimeter defining an air flow region configured to allow air to flow therethrough. The cart also includes a plurality of wheels rotatably connected to the support frame, a sensor support attached to or integrally formed with the outer perimeter of the support frame, a plurality of temperature sensors attached to the sensor support, and a sensor reading device. The sensor support extends vertically from the support frame and the temperature sensors attached to the sensor support each face away from the support frame, toward a server cabinet. The plurality of temperature sensors may include a first temperature sensor attached to a lower portion of the sensor support and a second temperature sensor attached to an upper portion of the sensor support. The sensor reading device may be communicably coupled to the plurality of temperature sensors and may store and/or display temperature readings from the plurality of temperature sensors.

In another embodiment, a method of consistent temperature logging in a data center may include a step of moving or rolling a temperature cart on wheels or castors to a first location at which an air flow region of the temperature cart is horizontally aligned with a first perforated door of a first server cabinet. The air flow region has one or more openings cut or formed through one or more horizontal supports of the temperature cart. The method may also include a step of obtaining temperature readings with a plurality of temperature sensors attached to a sensor support and facing the first perforated door of the first server cabinet while the temperature cart is at the first location. The sensor support is attached to or integrally formed with an outer perimeter of a support frame of the temperature cart and extends vertically from the support frame. The plurality of temperature sensors includes a first temperature sensor attached to a lower portion of the sensor support and a second temperature sensor attached to an upper portion of the sensor support. Furthermore, the method includes the steps of receiving the temperature readings with a sensor reading device communicably coupled to the plurality of temperature sensors storing and/or displaying the temperature readings received by the sensor reading device.

In yet another embodiment, a data center temperature cart includes a support frame having a plurality of vertical supports and a plurality of horizontal supports, as well as a plurality of wheels rotatably connected to the support frame. At least some of the horizontal supports have an outer perimeter and an inner perimeter defining an air flow region having one or more openings. The cart also includes a sensor support attached to or integrally formed with the outer perimeter of the at least some of the horizontal supports, a plurality of temperature sensors, and a sensor reading device. The sensor support has a fixed or adjustable height, is taller than the horizontal supports, and is horizontally aligned with the air flow region of the horizontal supports. The temperature sensors are attached to the sensor support and face away from the support frame. The temperature sensors include a first temperature sensor attached to a lower portion of the sensor support, a second temperature sensor attached to an upper portion of the sensor support, and a third temperature sensor attached to the sensor support at a point between the first and the second temperature sensor. The sensor reading device is communicably coupled to the temperature sensors and has a memory to store temperature readings from the temperature sensors and a display to display the temperature readings from the temperature sensors.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the current technology will be apparent from the following detailed description of the embodiments and the accompanying drawing figures.

### BRIEF DESCRIPTION OF DRAWINGS

Embodiments of the current technology are described in detail below with reference to the attached drawing figures, wherein:

FIG. 1 is an environmental rear perspective view of a temperature cart in a data center aligned for measuring server cabinet temperatures in accordance with embodiments herein;

FIG. 2 is a schematic drawing of a data center, depicting flow of cool and warm air in accordance with embodiments herein;

FIG. 3A is a perspective view of the cart of FIG. 1 with a lowest temperature sensor located within an air flow region of horizontal supports in accordance with embodiments herein;

FIG. 3B is a perspective view of the cart of FIG. 3A with the lowest temperature sensor mounted on a sensor support along with other temperature sensors in accordance with embodiments herein;

FIG. 4 is a fragmentary environmental top side perspective view of the temperature cart of FIG. 1, depicting an electronic accessory platform in accordance with embodiments herein;

FIG. 5 is a fragmentary environmental front perspective view of the temperature cart of FIG. 1 in accordance with embodiments herein;

FIG. 6 is a fragmentary environmental rear perspective view of the temperature cart of FIG. 1, depicting data loggers or sensor reading devices in accordance with embodiments herein; and

FIG. 7 is a flow chart depicting a method of consistent temperature logging in a data center in accordance with embodiments herein.

The drawing figures do not limit the current technology to the specific embodiments disclosed and described herein. The drawings are not necessarily to scale, emphasis instead being placed upon clearly illustrating the principles of the technology.

### DETAILED DESCRIPTION

The following detailed description of the technology references the accompanying drawings that illustrate specific embodiments in which the technology can be practiced. The embodiments are intended to describe aspects of the technology in sufficient detail to enable those skilled in the art to practice the technology. Other embodiments can be utilized and changes can be made without departing from the scope of the current technology described herein. The following detailed description is, therefore, not to be taken in a limiting sense. The scope of the current invention is defined only by the appended claims, along with the full scope of equivalents to which such claims are entitled.

In some traditional data centers, technicians go through once a month and document temperatures in each of the server cabinets. The data center may be split into zones where there are cabinets in rows, and within those zones technicians take temperature readings of each server cabinet to make sure nothing is overheated and also to track temperature swings to determine when that equipment (e.g., servers and other electronic equipment) started ramping up in speed and taking on additional load. The temperatures are traditionally obtained using a temperature gun that measures a surface temperature of the cabinet itself, and that data is charted for monitoring purposes. However, the temperatures may vary based on where the technicians took the temperature with that temperature gun. For example, a temperature taken at the bottom of the cabinet may not indicate any issues, but meanwhile there may be equipment overheating at the top of the cabinet that is not being taken into consideration due to the location where the temperature gun is pointed.

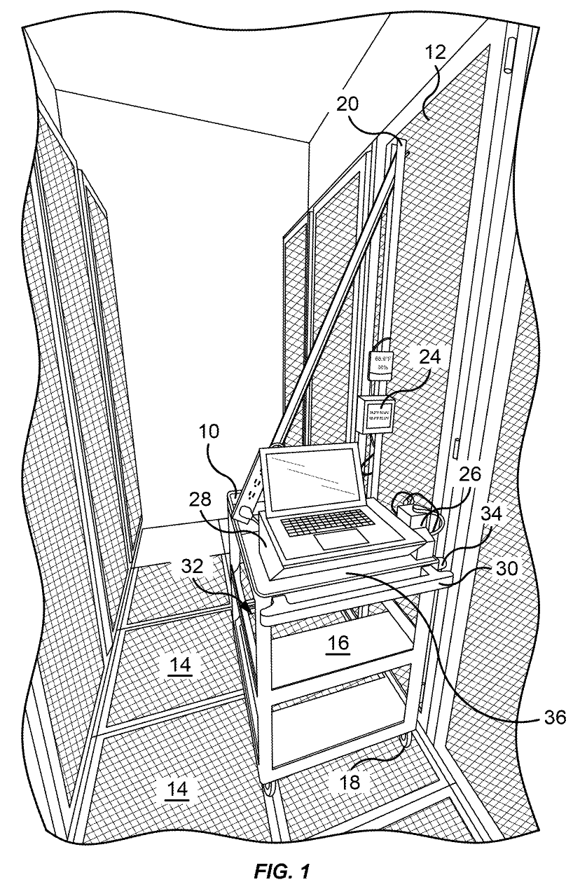

Thus, to improve on this prior art process, a temperature cart 10 as depicted in FIG. 1 is configured to take temperatures at precise locations at the server cabinet consistently each month, and knowing those temperatures from a bottom all the way to a top of the cabinet can advantageously help ensure that the required airflow for those cabinets is being met. In use, as air feeds through openings of the temperature cart 10, as described below, that air will hit an incoming sensor and at least two or three additional sensors supported by the cart and spaced alongside the cabinet in a vertical manner (e.g., bottom, middle, and top temperature sensors along a sensor support). However, any number of temperature sensors or probes can be used without departing from the scope of the technology, as described in more detail below.

The temperature cart described herein can be used in a data center environment where perforated tiles are fed from some supply air. For example, the temperature cart may be used in any data center that has a raised floor that is basically a supply duct pushing cold air directed toward the cabinet where the servers are located. All sensor information is captured by a data logger or other such electronic device that can read temperatures of multiple separate temperature sensors. In some server rooms or data centers, the perforated tiles are only placed in front of cabinets that have servers and electronic equipment therein, so that the cool air is used efficiently.

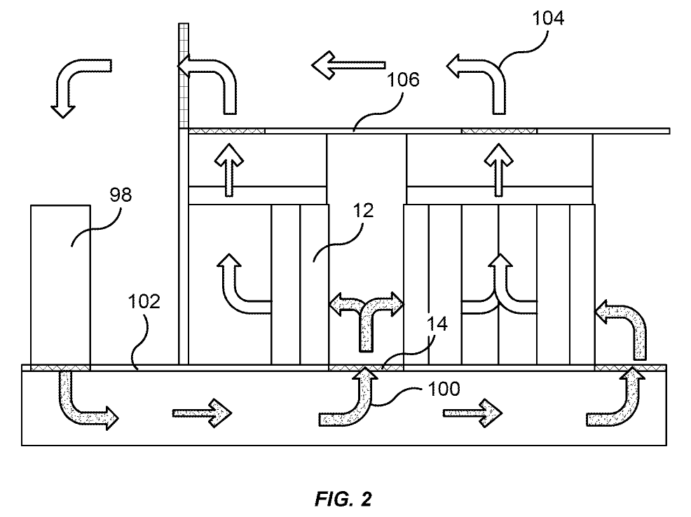

An exemplary data center environment is depicted in FIG. 2. As illustrated, computer room air handlers (CRAH units 98) or other such air conditioning units in a gallery (separate room) provide cold air (shaded arrows 100) into a duct that goes under the floor 102 and into perforated tiles 14, is drawn into server cabinets 12. The cabinets 12 have perforated doors and the servers have built-in fans to draw air into the server and keep its components from overheating, so cold air from the perforated floors or perforated tiles 14 is pulled into the cabinets 12 through the perforated doors. The air that is pulled into the cabinets 12 and pulled through the servers heats up (unshaded arrows 104) and is forced out or exhausted into a hot aisle or a hot aisle containment pod or room. That hot air flows into a dropped ceiling 106 or containment area/return duct above the cabinets 12 (via perforated or vented ceiling tiles) and the dropped ceiling serves as a return duct. From the dropped ceiling 106 or containment area/return duct, that hot air flows back into the gallery and back into the air conditioner or CRAH unit 98 for cooling and to begin the air flow cycle over again.

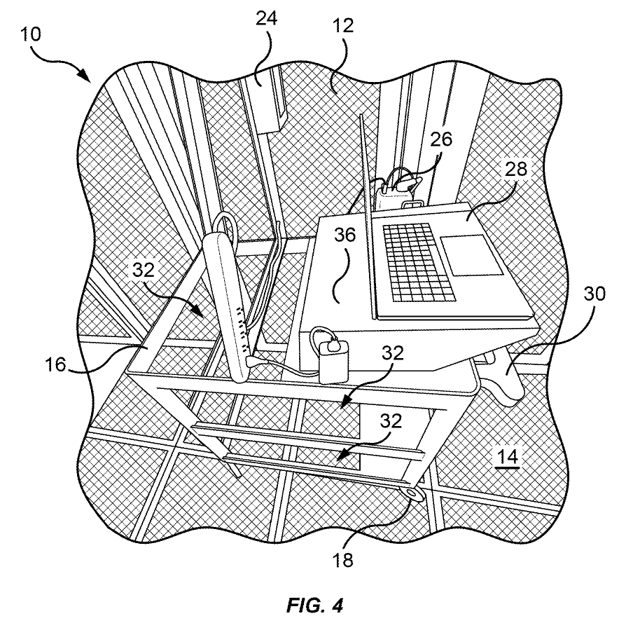

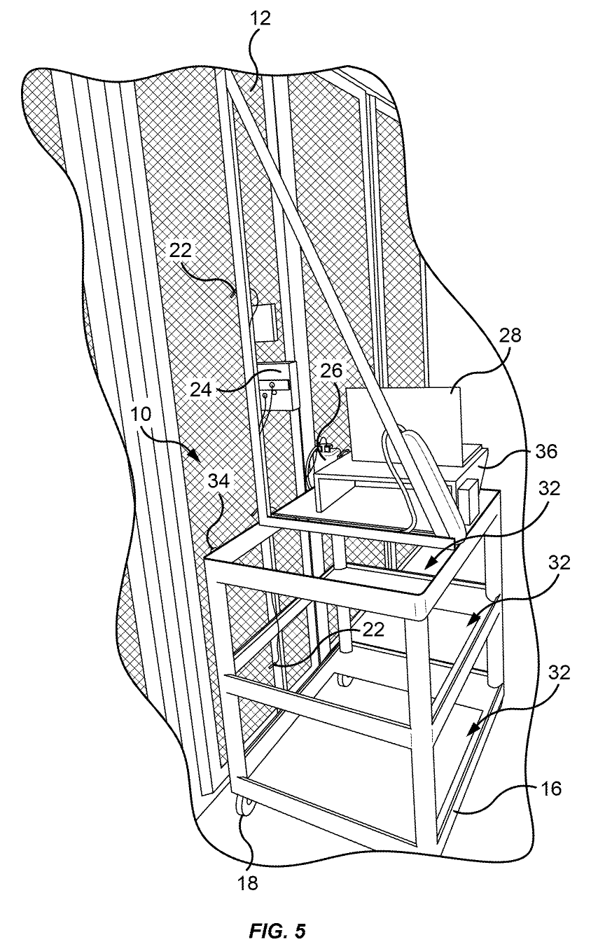

As depicted in FIGS. 1 and 3-6, the temperature cart 10 described herein can be used to measure temperatures of cabinets (e.g., the server cabinets 12) in a data center with a raised floor similar to the data center depicted in FIG. 2, or any server room or data center known in the art. The cabinets 12 may have a width of approximately thirty (30) inches, for example, but any width may be used without departing from the scope of the disclosure herein. The temperature cart 10 may be particularly useful in data centers or server rooms with one or more perforated tiles 14 forming the floor on which the temperature cart 10 rolls. The perforated tiles 14 may be configured for cooled or heated air to flow therethrough, such as those used in conjunction with the CRAH units described above. The temperature cart 10 may be used to measure the temperature of the cabinets 12 in a hot aisle and/or a cold aisle of the data center or server room.

The cart 10 comprises a support frame 16, a plurality of wheels 18 connected to the support frame 16, a sensor support 20, and a plurality of temperature sensors 22. In one or more embodiments, the cart 10 further includes a sensor reading device 24 and/or a remote power source 26 configured to provide power to the temperature sensors 22, the sensor reading device 24, and/or other electronic accessories 28 or devices placed on the cart 10 for utilization by a technician, such as a laptop, tablet, mobile phone, or other electronic devices.

The support frame 16 may comprise plurality of vertical supports and one or more horizontal supports extending between and connecting the vertical supports together. For example, the support frame 16 may be a three-shelf utility cart, with each of the shelves being one of the horizontal supports. In one or more embodiments, the support frame 16 may additionally comprise at least one cart handle 30 sized and shaped to be gripped by a user for pushing of the support frame 16 on the plurality of wheels 18 across a floor of the data center.

In one or more embodiments, at least some of the horizontal supports may have an outer perimeter and an inner perimeter defining at least one air flow region 32 comprising one or more openings. Specifically, the air flow region 32 may be sized, shaped, and configured to allow air forced through one of the one or more perforated tiles 14 up through the air flow region 32 of the cart 10 substantially unimpeded, such that the air flow may continue into an adjacent one of the server cabinets 12 (or a perforated door thereof) as intended while temperature measurements are being obtained. The air flow region 32 of each of the horizontal supports of the support frame 16 may be vertically aligned with each other in one or more embodiments herein. Conversely, traditional carts on wheels have solid bottom and solid top horizontal supports, so airflow to the temperature sensors is obstructed. However, the preferred holes or openings of the air flow region 32 are substantially the size of at least one of the perforated tiles 14 on a typical data center floor (e.g., two feet by two feet). In one or more embodiments, there may be some bracing throughout the air flow region 32 to provide stability, although such bracing may be omitted without departing from the scope of the technology described herein. For example, one or more of the air flow regions 32 in one or more of the horizontal supports may be entirely open, as depicted in FIG. 1, without the bracing described above.

In some example embodiments, the air flow region 32 formed through a first horizontal support (e.g., a bottom cart tray) comprises an opening with or without the bracing, and the airflow region formed through a second horizontal support (e.g., a top cart tray) comprises a similar or identically sized and shaped opening or air flow region 32 with or without the bracing described above. Furthermore, in one or more embodiments, a third horizontal support (e.g., a middle cart tray) has an opening sized and shaped to match the size and shape of the air flow regions 32 of the first and second horizontal supports. However, any number of horizontal supports may be features on the cart 10 without departing from the technology described herein. In one or more embodiments, the air flow regions 32 of each horizontal support may have a size and shape of the perforated tile 14 thereunder. In some alternative embodiments, the air flow region 32 of one or more of the horizonal supports may comprise a perforated region instead of an opening or an opening with brace, or the air flow region 32 may have a perforated vent or screen extending thereacross, with minimal or negligent impact on air flow therethrough.

In addition to the support frame components described above, in one or more embodiments the cart 10 further comprises one or more spacers 34 extending horizontally outward from the support frame 16 (e.g., extending outward from the outer perimeter and away from the support frame 16). In one or more embodiments, the spacers 34 may extend by a horizontal distance that is greater than a horizontal distance that any of the plurality of temperature sensors 22 extend, thus preventing the sensors from running into the cabinets 12 and providing a consistent positioning of the temperature sensors 22 relative to the cabinets 12 during the method steps described herein. The spacers 34 can be rubber or any desired material known in the art that is rigid enough to maintain desired spacing but also soft enough so as not to damage the cabinets 12 if scraped thereagainst. The spacers 34 may provide one to two or three inches of space between the cabinets 12 and the remaining components of the cart 10. However, other amounts of spacing may be provided without departing from the scope of the technology herein.

The wheels 18 may be rotatably connected to the support frame 16. For example, the wheels 18 may be castors (e.g., three, four, or more castors) or other wheels know in the art upon which the support frame 16 may travel when the cart 10 is pushed or otherwise actuated to be relocated within the data center. The castors may comprise wheels configured for rotating in a plurality of directions based on pivoting or free rotation (e.g., 360-degrees) of the castors relative to the support frame 16. The wheels 18 may include and/or be replaced with ball bearings, rollers, or tracks. In other alternative embodiments, the wheels 18 may even be replaced with skids, magnetic levitation systems, hovercraft systems, pully and lever systems, or other systems know in the art to mechanically transport the cart 10 from one location to another within the data center without departing from the scope of the technology described herein.

The sensor support 20 may be a structure sized and configured to support one or more of the plurality of temperature sensors 22 in desired locations relative to the cart 10 and relative to the cabinets 12. In one or more embodiments, the sensor support 20 is attached to or integrally formed with the outer perimeter of the support frame 16 at one or more locations, and/or attached elsewhere to one of the horizontal supports or vertical supports. The sensor support 20 may be taller than the horizontal supports and, in one or more embodiments, may be horizontally aligned with the air flow region 32 of the horizontal supports. The sensor support 20 may provide for the temperature sensors 22 to be fixed at differing heights relative to each other and relative to the cabinets 12 (or the perforated doors thereof) such that temperatures at different locations along each of the cabinets 12 can be obtained and recorded, as later described herein. Specifically, the sensor support 20 may extend substantially vertically from the support frame 16, and in one or more embodiments may be vertically adjustable (e.g., telescoping and locking means, mechanical folding means, or the like) in order to accommodate for data center cabinets and/or ceilings of different heights. For example, the sensor support 20 may be adjustable between a first height and a second height, or alternatively comprise adjustable attachments to the temperature sensors 22 such that one or more of the temperature sensors 22 are vertically adjustable between two or more locations along the support sensor 20.

The plurality of temperature sensors 22 may comprise air probes configured to measure air temperature. For example, the temperature sensors 22 may be configured to measure air temperature with one or more of a variety of air probes, such as thermistors, thermocouples, and RTDs. Conversely, an infrared (IR) temperature measures contact temperature on a surface, such as the cabinet surface or surface of the cabinet door. However, an air probe advantageously measures the air at a given point and gives a better indication of whether or not adequate air flow is being provided at the perforated tile 14, at a lower portion of the cabinet 12 aligned therewith, at a middle portion of the cabinet 12, and/or at a top portion of the cabinet 12. In one or more embodiments, additional temperature sensors may be used to provide even greater accuracy, such as a group of left side sensors and a group of right side sensors.

Additionally or alternatively, other temperature sensors may be used without departing from the scope of the technology described herein. The temperature sensors 22 may each be attached to the sensor support 20 and/or the support frame 16 such that each of the temperature sensors 22 faces away from the sensor support 20 and/or the support frame 16. For example, the sensor support 20 may extend vertically relative to the support frame 16 to present an upper portion extending above the support frame 16 and a lower portion extending downwardly from the upper portion. In one or more embodiments, at least one of the temperature sensors 22 may be attached to the lower portion of the sensor support 20 and at least one of the temperature sensors 22 may be attached to the upper portion of the sensor support 20. In one or more embodiments, the temperature sensors 22 comprise a first temperature sensor attached below a midway point of the sensor support 20 and a second temperature sensor attached above the midway point of the sensor support 20.

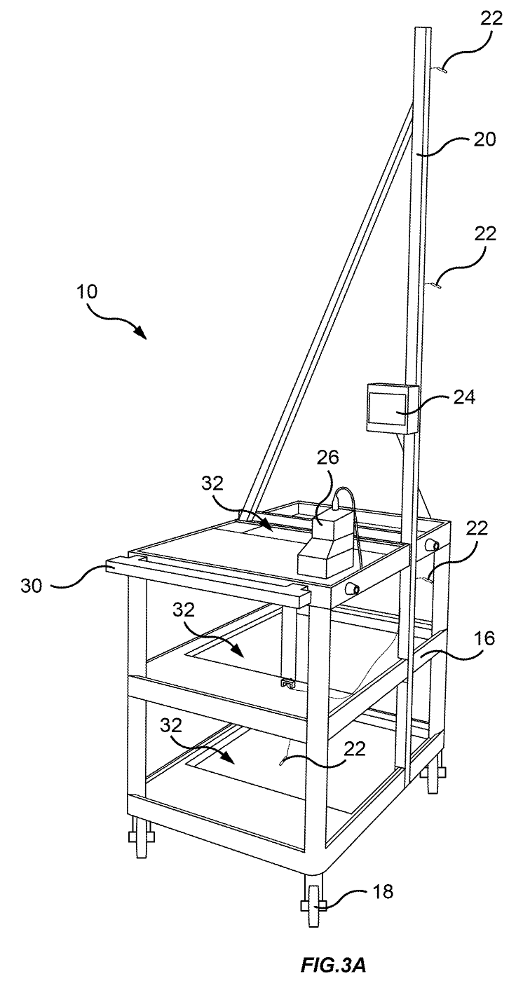

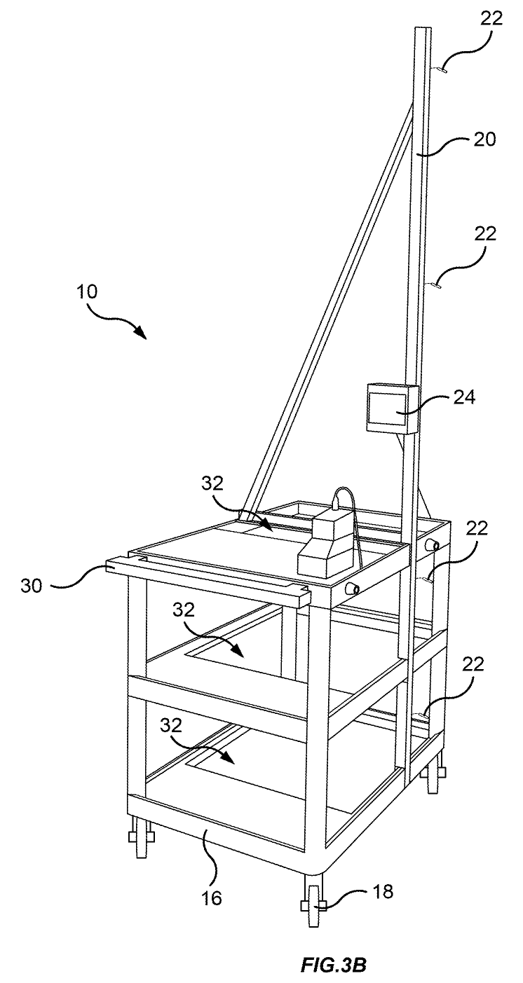

In one or more embodiments, the temperature sensors 22 may further comprise a third temperature sensor attached to the sensor support 20 at a point between the first and the second temperature sensor. This allows a top, bottom, and middle portion of the cabinets 12 to be measured for a temperature of air flowing into the perforated doors of each of the cabinets 12, and provides for a consistent reading each time, as opposed to handheld temperature measurement devices which can pick up different readings because of user error (e.g., placement of sensor not being consistent from one measurement to the next). Furthermore, in one or more embodiments, the temperature sensors 22 further comprise a fourth temperature sensor attached to the sensor support 20 (as in FIG. 3b) or the support frame 16 (as in FIG. 3a) and directed toward the air flow region 32 to measure air flowing upward through the air flow region 32. In one or more embodiments, the configurations of FIGS. 3a and 3b may be combined such that there is a fifth temperature sensor (e.g., four spaced along a length of the sensor support 20 and one located within the air flow region 32 to obtain a true reading of air at floor level from the perforated tiles 14).

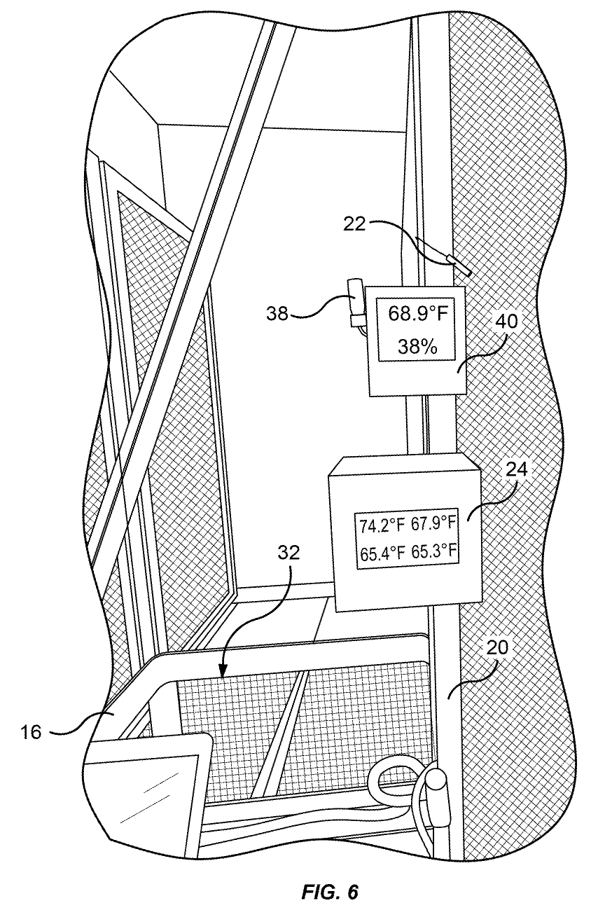

However, other quantities and types of sensors may be used as part of the cart 10 described herein without departing from the scope of the disclosure herein. For example, as depicted in FIG. 6, in one or more embodiments, in addition to the temperature sensors 22, a humidity detector 38 (e.g., Digital Hygrometer: Indoor/Outdoor, Temp, Humidity by EXTECH INSTRUMENTS, headquartered in Nashua, New Hampshire) may be attached to the cart 10 to provide a humidity reading of the data center or server room. In one or more embodiments, a separate data logger 40 may be associated with the humidity detector 38. Alternatively, a single data logger or processing element may be associated with any combination of the sensors described herein. Additionally or alternatively, one or more microphones or decibel reading sensors may be provided on the cart 10 to obtain audio readings related to the amount of noise in the server room or data center for technician safety (e.g., indicate if ear protection is needed) and/or to provide indications of problems with equipment in the server cabinets 12.

The sensor reading device 24 may be communicably coupled to each of the plurality of temperature sensors 22 and configured to at least one of store and/or display temperature readings from the temperature sensors 22. For example, the sensor reading device 24 may comprise a processing element or other processing circuitry, memory, a display for outputting the temperature sensor readings (e.g., a visual computer display), a speaker, and/or a wired or wireless communication device configured for outputting sensor readings from the temperature sensors 22 or other sensors described herein to an electronic accessory or other electronic device for storing and/or processing thereof.

In one or more embodiments, the sensor reading device 24 is a data logger (e.g., LASCAR Temperature Data Logger, manufactured by LASCAR ELECTRONICS, headquartered in Whiteparish, Salisbury, Wiltshire, United Kingdom) wired to and/or wirelessly coupled with the temperature sensors 22. The sensor reading device 24 includes a display configured to display a readout of the temperatures measured by the temperature sensors 22, store that information along with what time that data was obtained, and/or communicate that information and/or the time that data was obtained to an external device such as a laptop, tablet, phone, or the like. For example, the data logger may include a processor, on-board memory for storing data from the temperature sensors 22, and/or a wireless communication device or a wired communication port by which the data logger can transmit data to external devices.

The remote power source 26 may be a portable battery (e.g., 18V DC power supply by MILWAUKEE ELECTRIC TOOL CORP., based in Brookfield, Wisconsin or any other battery known in the art) and/or may include an inverter associated therewith. The battery may be electrically coupled to provide power to the temperature sensors 22, the sensor reading device 24, or any combination thereof. For example, the inverter may take the DC power of the battery, change it to 5v out, for example, and provide that output to the sensor reading device 24 for operation thereof. In one or more embodiments, the remote power source 26 may be electrically coupled to and/or comprise a USB port configured for powering the temperature sensors 22 and/or the sensor reading device 24. However, other types of outlets may be used and/or hardwired to the power source 26 in order to power the components of the cart 10 without departing from the scope of the technology disclosed herein. In one or more embodiments, the remote power source 26 (e.g., the battery and the inverter associated therewith) may additionally or alternatively be electrically coupled to and/or include an outlet electrically couplable to a power strip which can be used to charge or power an electronic accessory 28 such as a laptop or other such electronic devices on the cart 10.

In one or more embodiments, the cart 10 may further comprise an electronic accessory platform 36 attached to the support frame 16 and having a top surface positioned at a fixed or adjustable height above the support frame 16. The electronic accessory platform 36 may support one or more electronic accessories 28 thereon, such as a laptop, a tablet, a mobile phone, or the like. Furthermore, the battery may be configured with outlets suitable for electrically coupling to one or more of the electronic accessories 28. The electronic accessory platform 36 may be positioned proximate to the remote power source 26 or battery described above for providing power to the electronic accessories 28, or the remote power source 26 may even be supported by the electronic accessory platform 36 in one or more embodiments. The electronic accessory platform 36 may be provided on a portion of one of the horizontal supports at a height sufficient for typing when a technician is standing and a keyboard or laptop is placed thereon. For example, in one or more embodiments the platform may be a substantially flat surface located between thirty-five (35) inches to fifty (50) inches relative to the floor or the perforated tiles 14 on which the cart 10 rests. However, other heights may be used without departing from the scope of the technology described herein. Furthermore, in one or more embodiments, the platform may be adjustable in height and/or adjustable in angle, such that this flexibility may allow for ideal ergonomics for different technicians to be achieved.

Although only one sensor support is depicted herein, some alternative embodiments may further comprise a supplemental sensor support (not shown) attached to or integrally formed with the cart 10 in substantially the same manner as the sensor support 20. The supplemental sensor support may also be constructed in the same manner as the sensor support 20. For example, the supplemental sensor support may be attached to or integrally formed with the outer perimeter of the support frame 16 on an opposite side of the outer perimeter of the support frame 16 than the sensor support 20. The supplemental sensor support may likewise extend vertically from the support frame 16 and support additional ones of the plurality of temperature sensors 22 facing outward away from the cart 10 and/or in a substantially opposite direction relative to the temperature sensors 22 on the sensor support 20. This advantageously may provide the cart 10 with the ability to measure cabinets on opposite sides of an aisle from each other without requiring the cart 10 to turn around at an end of a narrow aisle. Furthermore, any plurality of temperature supports substantially identical to the sensor support 20, with any number of temperature sensors substantially identical to the temperature sensors 22 may be added to the cart 10 in a substantially identical manner without departing from the scope of the technology described herein.

In use, consistent positioning of the cart 10 relative to the cabinet 12 can be determined by centering the sensor support 20 and/or centering the perforated tile 14 with the holes or air flow regions 32 through the cart 10. For example, if one of the perforated tiles 14 is aligned with one of the cabinets 12 or one of the cabinet doors, then a location where the air flow regions 32 are located may be aligned with the perforated tile 14 to achieve a desired consistent location of the temperature sensors 22 relative to the cabinet 12 or the cabinet door. Additionally or alternatively, the at least one cart spacer 34, boot, or protrusion extending outward from the vertical or horizontal supports may be positioned against a door of the cabinet 12 to maintain a desired spacing between the temperature sensors 22 and the perforated door of any of the cabinets 12 and/or a desired spacing between other elements of the cart 10 and the perforated door of any of the cabinets 12. Beyond providing consistent positioning of the cart 10, the at least one spacer also prevents the temperature sensors 22 from damaging contact with the cabinets 12 and avoids mistaken contact sensing of the cabinet door itself.

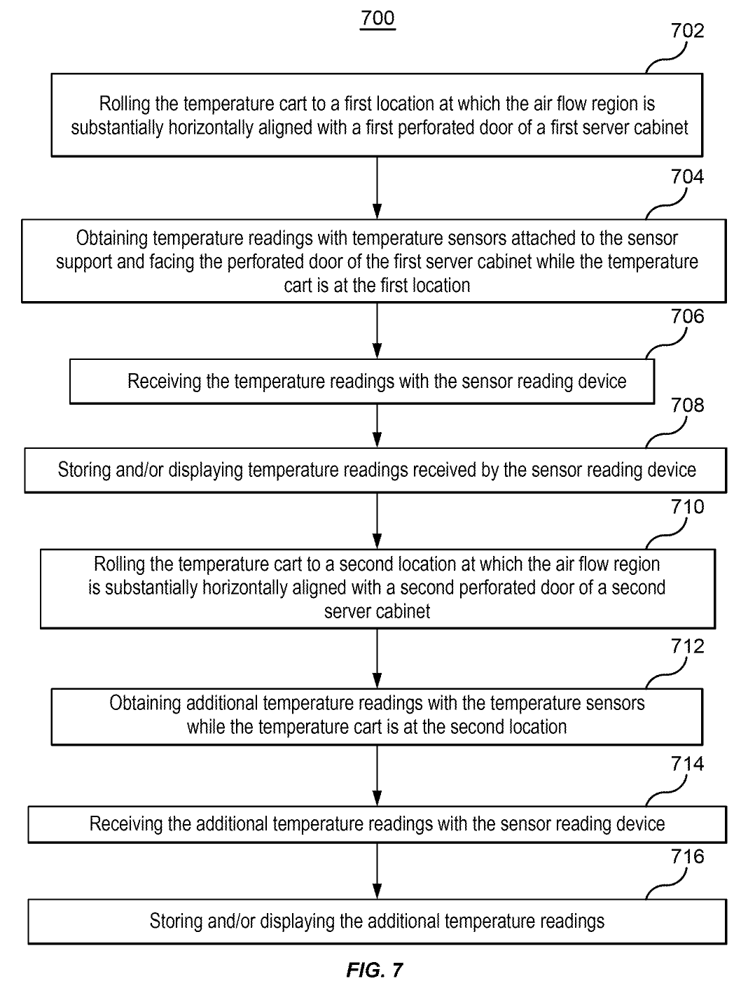

The flow chart of FIG. 7 depicts an exemplary method 700 for using the cart 10 to consistently sense and log temperatures in a data center in more detail. In one or more embodiments, various steps may be omitted, or steps may occur out of the order depicted in FIG. 7 without departing from the scope of the technology as described herein. For example, two blocks shown in succession in FIG. 7 may in fact be executed substantially concurrently, or blocks may sometimes be executed in the reverse order depending upon the functionality involved.

In one or more embodiments, the method 700 may include a step of moving (e.g., rolling) the temperature cart 10 on its wheels 18 or castors to a first location at which the air flow region 32 of the temperature cart 10 is substantially horizontally aligned with a first perforated door of a first server cabinet (e.g., one of the server cabinets 12), as depicted in block 702. In one or more embodiments, when the cart 10 is at the first location, the outer perimeter is a fixed distance away from the first perforated door, and the fixed distance is maintained by one or more spacers (e.g., the spacers 34) extending horizontally outward from the outer perimeter and abutting the first perforated door. That is, the step of moving the temperature cart 10 to the first location may further include: abutting the first server cabinet or an adjacent server cabinet with the one or more spacers 34 extending horizontally outward from the outer perimeter to maintain the outer perimeter a fixed distance away from the first perforated door when the temperature cart 10 is in the first location. As described above, the air flow region 32 of the cart 10 has one or more openings cut or otherwise formed through one or more of the horizontal supports, so that air flows from the perforated tiles 14 therebelow and through the air flow region 32 of the cart 10. In one or more embodiments, when the cart 10 is at the first location, the air flow region 32 of the temperature cart 10 extends over and is aligned with a perforated floor tile (e.g., one of the perforated tiles 14) through which heated or cooled air is forced toward the first server cabinet. That is, the step 702 of moving the temperature cart 10 to the first location may include a step of aligning the air flow region 32 (e.g., the one or more openings cut or formed through one or more horizontal supports) of the temperature cart 10 with one of the perforated floor tiles through which heated or cooled air is forced.

The method 700 further includes a step of obtaining temperature readings with the plurality of temperature sensors 22 attached to the sensor support 20 and facing the first perforated door of the first server cabinet while the temperature cart 10 is at the first location, as depicted in block 704. This obtaining step may be activated by a technician pushing the cart 10, via pushing of a button associated with logging sensor data or otherwise activating the temperature sensors 22 via the sensor reading device 24.

The method 700 further includes the steps of receiving the temperature readings with the sensor reading device 24, as depicted in block 706, and at least one of storing and displaying temperature readings received by the sensor reading device 24, as depicted in block 708. The use of the cart 10 for obtaining these readings provides temperature readings of input air from the perforated tiles 14 on the floor, as well as air at a plurality of locations just outside of the perforated door of the cabinet, and allows for periodic (e.g., monthly) readings of each of the cabinets 12 to be performed in a standardized manner and sensor location, providing more accurate and complete data and thus providing better indication to the technician or others reviewing the periodic data if there are air flow issues with any of the equipment of the data center.

In one or more embodiments, the method 700 may further include a step of moving (e.g., rolling) the temperature cart 10 to a second location at which the air flow region 32 of the temperature cart 10 is horizontally aligned with a second perforated door of a second server cabinet, as depicted in block 710, obtaining additional temperature readings with the plurality of temperature sensors 22 while the temperature cart 10 is at the second location, as depicted in block 712, receiving the additional temperature readings with the sensor reading device 24, as depicted in block 714, and at least one of storing and displaying the additional temperature readings, as depicted in block 716. Similar to earlier steps described herein, the step 710 of moving the temperature cart 10 to the second location may include a step of aligning the air flow region 32 (e.g., the one or more openings cut or formed through one or more horizontal supports) of the temperature cart 10 with one of the perforated floor tiles through which heated or cooled air is forced.

Note that these steps of method 700 may be repeated any number of times for additional locations and server cabinets in a data center or multiple data centers or server rooms without departing from the scope of the disclosure provided herein. This may include obtaining temperature readings of multiple cabinets in multiple aisles (e.g., cold aisles and/or hot aisles), as well as along opposing/facing sides of a same aisle. Other steps relating to obtaining, storing, and/or displaying other sensor data may also be added to the method 700 without departing from the scope of the technology herein, such as audio or humidity data as described above herein.

While the cart 10 and the methods described herein are depicted in FIGS. 1-7, note that substitutions or design alterations may be made without departing from the scope of the technology herein. For example, in some alternative embodiments, the cart 10 may further include a motor (not shown) or other systems and electronics sufficient to make the cart 10 autonomous, such that the cart 10 is self-driving and does not require a human technician. Such an automous system may have various processing elements that communicate electronically and/or wirelessly with the sensor reading device 24, the sensors, and or other sensors and electronics described herein in order to perform some or all of the method steps described herein.

Throughout this specification, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current technology can include a variety of combinations and/or integrations of the embodiments described herein.

Although the present application sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as a processing element, may be implemented as special purpose or as general purpose. For example, the processing element may comprise dedicated circuitry or logic that is permanently configured, such as an application-specific integrated circuit (ASIC), or indefinitely configured, such as an FPGA, to perform certain operations. The processing element may also comprise programmable logic or circuitry (e.g., as encompassed within a general-purpose processor or other programmable processor) that is temporarily configured by software to perform certain operations. It will be appreciated that the decision to implement the processing element as special purpose, in dedicated and permanently configured circuitry, or as general purpose (e.g., configured by software) may be driven by cost and time considerations.

Accordingly, the term “processing element” or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processing element is temporarily configured (e.g., programmed), each of the processing elements need not be configured or instantiated at any one instance in time. For example, where the processing element comprises a general-purpose processor configured using software, the general-purpose processor may be configured as respective different processing elements at different times. Software may accordingly configure the processing element to constitute a particular hardware configuration at one instance of time and to constitute a different hardware configuration at a different instance of time.

Computer hardware components, such as communication elements, memory elements, processing elements, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, at a later time, access the memory device to retrieve and process the stored output. Computer hardware components may also initiate communications with input or output devices, and may operate on a resource (e.g., a collection of information).

The various operations of example methods described herein may be performed, at least partially, by one or more processing elements that are temporarily configured (e.g., by software) or permanently configured to perform the relevant operations. Whether temporarily or permanently configured, such processing elements may constitute processing element-implemented modules that operate to perform one or more operations or functions. The modules referred to herein may, in some example embodiments, comprise processing element-implemented modules.

Similarly, the methods or routines described herein may be at least partially processing element-implemented. For example, at least some of the operations of a method may be performed by one or more processing elements or processing element-implemented hardware modules. The performance of certain of the operations may be distributed among the one or more processing elements, not only residing within a single machine, but deployed across a number of machines. In some example embodiments, the processing elements may be located in a single location (e.g., within a home environment, an office environment or as a server farm), while in other embodiments the processing elements may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processing element and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

The patent claims at the end of this patent application are not intended to be construed under 35 U.S.C. § 112(f) unless traditional means-plus-function language is expressly recited, such as “means for” or “step for” language being explicitly recited in the claim(s).

Although the technology has been described with reference to the embodiments illustrated in the attached drawing figures, it is noted that equivalents may be employed and substitutions made herein without departing from the scope of the technology as recited in the claims.

Having thus described various embodiments of the technology, what is claimed as new and desired to be protected by Letters Patent includes the following:

1. A data center temperature cart comprising:
a support frame having an outer perimeter;
a plurality of wheels rotatably connected to the support frame;
a sensor support attached to or integrally formed with the support frame, wherein the sensor support extends vertically relative to the support frame to present an upper portion extending above the support frame and a lower portion extending downwardly from the upper portion;
a plurality of temperature sensors attached to the sensor support and facing away from the support frame, the plurality of temperature sensors comprising a first temperature sensor attached to the lower portion of the sensor support and a second temperature sensor attached to the upper portion of the sensor support; and
a sensor reading device communicably coupled to the plurality of temperature sensors and configured to at least one of store and display temperature readings from the plurality of temperature sensors.

2. The data center temperature cart of claim 1, wherein the plurality of temperature sensors further comprises a third temperature sensor attached to the sensor support at a point between the first and the second temperature sensor.

3. The data center temperature cart of claim 1, wherein the support frame has an inner perimeter defining an air flow region configured to allow air to flow upwardly therethrough, and wherein the plurality of temperature sensors further comprises a fourth temperature sensor attached to the sensor support or the support frame and directed toward the air flow region to measure air flowing upwardly through the air flow region.

4. The data center temperature cart of claim 1, wherein each of the plurality of temperature sensors is an air probe configured to measure air temperature.

5. The data center temperature cart of claim 1, further comprising one or more spacers extending horizontally outward from the outer perimeter and away from the support frame by a horizontal distance that is greater than a horizontal distance any of the plurality of temperature sensors extend.

6. The data center temperature cart of claim 1, further comprising a supplemental sensor support attached to or integrally formed with the outer perimeter of the support frame on an opposite side of the outer perimeter of the support frame than the sensor support, wherein the supplemental sensor support extends vertically from the support frame and supports additional ones of the plurality of temperature sensors.

7. The data center temperature cart of claim 1, further comprising a battery electrically coupled to provide power to the plurality of temperature sensors, the sensor reading device, or any combination thereof.

8. The data center temperature cart of claim 1, wherein the sensor support is adjustable between a first height and a second height or one or more of the plurality of temperature sensors are vertically adjustable between two or more locations along the support sensor.

9. The data center temperature cart of claim 1, further comprising a humidity detector.

10. The data center temperature cart of claim 1, wherein the plurality of wheels comprise three or more castors.

11. The data center temperature cart of claim 1, further comprising an electronic accessory platform attached to the support frame and having a top surface positioned at a fixed or adjustable height above the support frame.

12. A method of consistent temperature logging in a data center, the method comprising:
moving a mobile temperature cart to a first location at which an air flow region of the temperature cart is horizontally aligned in front of a first perforated door of a first server cabinet;
obtaining temperature readings with a plurality of temperature sensors attached to a sensor support and facing the first perforated door of the first server cabinet while the temperature cart is at the first location, wherein the sensor support is attached to or integrally formed with a support frame of the temperature cart and extends vertically relative to the support frame to present an upper portion extending above the support frame and a lower portion extending downwardly from the upper portion, wherein the plurality of temperature sensors comprise a first temperature sensor attached to the lower portion of the sensor support and a second temperature sensor attached to the upper portion of the sensor support; and
receiving the temperature readings with a sensor reading device communicably coupled to the plurality of temperature sensors; and
at least one of storing and displaying the temperature readings received by the sensor reading device.

13. The method of claim 12, further comprising: abutting the first server cabinet or an adjacent server cabinet with one or more spacers extending horizontally outward from the outer perimeter to maintain the outer perimeter a fixed distance away from the first perforated door when the temperature cart is in the first location.

14. The method of claim 12, wherein the step of moving the temperature cart to a first location includes the step of aligning one or more openings cut or formed through one or more horizontal supports of the temperature cart with a perforated floor tile through which heated or cooled air is forced.

15. The method of claim 12, further comprising the steps of:
moving the temperature cart to a second location at which the air flow region of the temperature cart is horizontally aligned with a second perforated door of a second server cabinet;
obtaining additional temperature readings with the plurality of temperature sensors while the temperature cart is at the second location;
receiving the additional temperature readings with the sensor reading device; and
at least one of storing and displaying additional temperature readings.

16. The method of claim 12, wherein the plurality of temperature sensors further comprises a third temperature sensor attached to the sensor support at a point between the first and the second temperature sensor.

17. The method of claim 12, wherein the plurality of temperature sensors further comprises a fourth temperature sensor attached to the sensor support or the support frame and directed toward a perforated floor tile to measure air exiting the perforated floor tile.

18. The method of claim 12, wherein the plurality of temperature sensors are air probes configured to measure air temperature.

19. A data center temperature cart comprising:
a support frame having a plurality of vertical supports and a plurality of horizontal supports, wherein at least some of the horizontal supports have an outer perimeter and an inner perimeter defining an air flow region comprising one or more openings;
a plurality of wheels rotatably connected to the support frame;
a sensor support attached to or integrally formed with the outer perimeter of the at least some of the horizontal supports, wherein the sensor support is taller than the horizontal supports and is horizontally aligned with the air flow region, wherein the sensor support has a fixed or adjustable height, wherein the support frame of the temperature cart extends vertically relative to the support frame to present an upper portion extending above the support frame and a lower portion extending downwardly from the upper portion;
a plurality of temperature sensors attached to the sensor support and facing away from the support frame, the plurality of temperature sensors comprising a first temperature sensor attached to the lower portion of the sensor support, a second temperature sensor attached to the upper portion of the sensor support, and a third temperature sensor attached to the sensor support at a point between the first and the second temperature sensor; and
a sensor reading device communicably coupled to the plurality of temperature sensors, the sensor reading device comprising memory configured to store temperature readings from the plurality of temperature sensors and a display configured to display the temperature readings from the plurality of temperature sensors.

20. The data center temperature cart of claim 1, wherein the plurality of temperature sensors further comprises a fourth temperature sensor attached to the sensor support or the support frame and directed toward the air flow region such that the fourth temperature sensor is positioned to measure air flowing from below the air flow region and up through the air flow region.
